(19) United States
(12) Patent Application Publication
(10) Pub. No.: US 2025/0390263 A1
(43) Pub. Date: Dec. 25, 2025

(54) NON-TRANSITORY COMPUTER READABLE STORAGE MEDIUM, SERVER, AND LABEL DATA SHARING SYSTEM

(71) Applicant: BROTHER KOGYO KABUSHIKI KAISHA, Nagoya (JP)

(72) Inventor: Ryoji Ban, Kiyosu (JP)

(21) Appl. No.: 19/313,789

(22) Filed: Aug. 28, 2025

Related U.S. Application Data
(63) Continuation of application No. PCT/JP2024/010733, filed on Mar. 19, 2024.

(30) Foreign Application Priority Data
Mar. 31, 2023 (JP) 2023-058402

(51) Int. Cl. G06F 3/12

(52) U.S. Cl. CPC G06F 3/1273; G06F 3/1203

(57) ABSTRACT

A non-transitory computer readable storage medium storing a program executable by a server, the server being capable of accessing a label database, the label database being capable of registering a plurality of piece of label data, the label data including medium information indicating a printing medium. The program causes a computer of the server to execute, when a list request is received from the information processing device, an acquisition process of acquiring, by an information processing device, main body medium information which is medium information acquired from a label printer, an extraction process of accessing the label database and extracting the label data including medium information corresponding to the main body medium information acquired in the acquisition process, and a return process of returning, to the information processing device, a label data list including the label data extracted in the extraction process.

### REFERENCE TO RELATED APPLICATIONS

This is a continuation application of International Application No. PCT/JP2024/010733 filed on Mar. 19, 2024, which claims priority from Japanese Patent Application No. 2023-058402 filed on Mar. 31, 2023. The entire contents of the aforementioned applications are incorporated herein by reference.

### BACKGROUND ART

In a related art, as a system for sharing content data, a system is known in which a server for storing content data is prepared on the Internet and the content data is downloaded to a device of a user.

In a point management system disclosed in the related art, photograph data is uploaded from a PC of a user A to a WWW server, and the photograph data is purchased by a PC of a user B and downloaded from the WWW server.

In recent years, a system for sharing label data used for printing a label in a label printer has been studied. Since a plurality of pieces of label data are registered in the server, in such a system, when a user of the system selects label data, a mechanism for recommending label data according to the preference of the user is desired. The related art discloses a system for sharing photograph data via a WWW server, but does not disclose a mechanism for recommending photograph data.

### SUMMARY

A non-transitory computer readable storage medium storing a program executable by a server, the server being capable of accessing a label database, the label database being capable of registering a plurality of piece of label data, the label data including medium information indicating a printing medium, wherein
the program causes a computer of the server to execute,
when a list request is received from the information processing device,
   an acquisition process of acquiring, by an information processing device, main body medium information which is medium information acquired from a label printer,
   an extraction process of accessing the label database and extracting the label data including medium information corresponding to the main body medium information acquired in the acquisition process, and
   a return process of returning, to the information processing device, a label data list including the label data extracted in the extraction process.

### BRIEF DESCRIPTION OF THE DRAWINGS

FIG. 1 is a diagram schematically illustrating a label data sharing system.

FIG. 2 is a diagram schematically illustrating a configuration of a terminal.

FIG. 3 is a sequence diagram illustrating an example of a posting procedure.

FIG. 4 is a diagram illustrating an example of screen transition.

FIG. 5 is a diagram illustrating an example of a label database.

FIG. 6 is a sequence diagram illustrating an example of a printing procedure.

FIG. 7 is a sequence diagram illustrating an example of a download procedure.

FIG. 8 is a diagram illustrating an example of a download screen.

FIG. 9 is a diagram schematically illustrating a label data sharing system.

FIG. 10 is a sequence diagram illustrating an example of the printing procedure.

FIG. 11 is a diagram illustrating an example of a printing log database.

FIG. 12 is a sequence diagram illustrating an example of the download procedure.

### DESCRIPTION

Hereinafter, embodiments embodying a label data sharing system will be described in detail with reference to the accompanying drawings. The present embodiment discloses a label data sharing system in which a server and a plurality of information processing devices are connected via a network to share label data used for printing a label in a label printer.

### First Embodiment

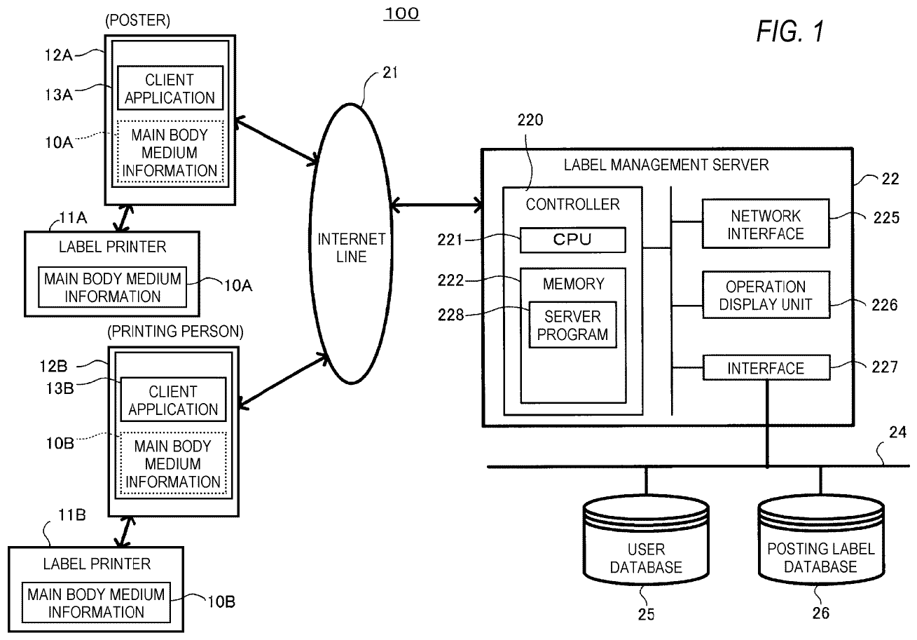

As illustrated in FIG. 1, a label data sharing system 100 (hereinafter abbreviated as “system 100”) according to a first embodiment is, for example, a system provided to a user by a vendor that is a manufacturer of a label printer. The system 100 includes a terminal 12A, a terminal 12B, and a label management server 22, which are connected via an Internet line 21. The terminals 12A and 12B are terminals owned by an owner or a user (hereinafter referred to as a “user”) of the label printer. The terminals 12A and 12B can be connected to label printers 11A and 11B, respectively. The label printers 11A and 11B store main body medium information 10A and 10B, respectively, which are medium information related to a tape to be loaded. The tape is an example of a “printing medium”.

The terminals 12A and 12B are information processing devices having a communication function, a display function, and an operation function. The terminals 12A and 12B according the present embodiment are implemented by smartphones, and may be implemented by tablets or personal computers. The terminals 12A and 12B store client application programs (hereinafter referred to as “client applications”) 13A and 13B, respectively. The number of terminals connected to the label management server 22 is not limited to the present embodiment. In addition, the terminals 12A and 12B may be collectively referred to as a “terminal 12” when it is not particularly necessary to distinguish the terminals 12A and 12B from each other. The client applications 13A and 13B may be collectively referred to as a “client application 13” when it is not particularly necessary to distinguish the client applications 13A and 13B from each other. In addition, the label printers 11A and 11B may be collectively referred to as a “label printer 11” when it is not particularly necessary to distinguish the label printers 11A and 11B from each other. The main body medium information 10A and 10B may be collectively referred to as “main body medium information 10” when it is not particularly necessary to distinguish the main body medium information 10A and 10B from each other.

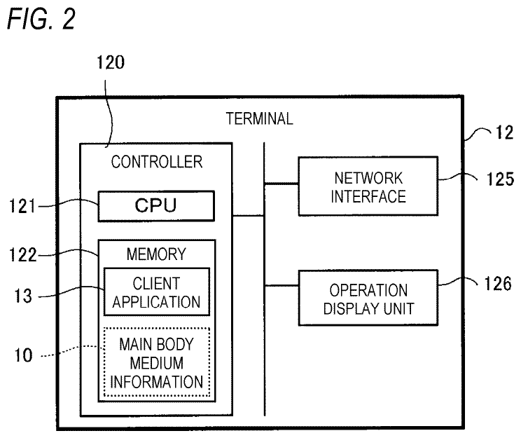

As illustrated in FIG. 2, the terminal 12 includes a controller 120 including a CPU 121 and a memory 122. The terminal 12 includes a network interface (hereinafter referred to as a “network IF”) 125 and an operation display unit 126, which are connected to the controller 120.

The label management server 22 illustrated in FIG. 1 is a device having at least a storage function and a communication function. The label management server 22 includes a controller 220 including an CPU 221 and a memory 222. The label management server 22 includes a network interface (hereinafter referred to as a “network IF”) 225, an operation display unit 226, and an interface 227, which are connected to the controller 220. The label management server 22 according to the present embodiment has a web server function, and can provide a web page to an external device such as the terminal 12.

The terminal 12B of a user who prints the label data (hereinafter referred to as a “printing person”) is an example of an “information processing device”. The CPU 121 is an example of a “computer of the information processing device”. The controller 120 may be an example of the “computer of the information processing device”. The operation display unit 126 is an example of a “user interface”. The client application 13B is an example of a “program executable by an information processing device connectable to a label printer”. The label management server 22 is an example of a “server”. The Internet line 21 is an example of a “network”. The CPU 221 is an example of a “computer of a server”. The controller 220 may be an example of the “computer of the server”.

The CPUs 121 and 221 are configured to execute various types of processes, in accordance with a program read from the memories 122 and 222 and based on a user's operation. The memories 122 and 222 are storage areas in which various programs and various data are stored. For example, the memory 122 stores the client application 13 and the main body medium information 10. For example, the memory 222 stores a server program 228. The memories 222 and 122 are used as a work area in a case where various types of processes are executed.

Examples of the memories 122 and 222 are not limited to a ROM, a RAM, an HDD, and the like incorporated into the device, and may be media readable and writable by the CPUs 121 and 221. The storage media readable by the CPUs 121 and 221 include recording media such as a CD-ROM and a DVD-ROM in addition to the above examples.

The operation display units 126 and 226 include hardware configured to display a screen for notifying a user of information, and hardware configured to receive an operation from the user. The operation display units 126 and 226 may be a touch panel having both a display function and an operation reception function, or may be a set of a display having a display function and a keyboard, a mouse, a trackball, or the like having an operation reception function.

The network IFs 125 and 225 include hardware for communicating with an external device. Communication standards of the network IFs 125 and 225 include Ethernet (registered trademark), Wi-Fi (registered trademark), and the like. The communication mode of the network IFs 125 and 225 may be wired or wireless. The network IFs 125 and 225 according to the present embodiment are connected to the Internet line 21.

The client application 13 stored in the terminal 12 is an application program provided by the vendor of the label printer 11. The client application 13 has a function of creating and editing label data on the terminal 12. The client application 13 has a function of posting, that is, uploading, the created label data to the label management server 22. The client application 13 has a function of downloading label data from the label management server 22. The client application 13 has a function of printing the label data created on the terminal 12 and the downloaded label data using the label printer 11.

The label printer 11 is, for example, a printing device that includes a thermal transfer type print head and performs printing while unwinding a tape wound in a roll shape. For example, the label printer 11 prints an image on the accommodated tape and conveys the tape based on a print job received from the terminal 12, and causes the printed portion to protrude to an outside of the machine. A label having a predetermined label length and a predetermined label width is created by the tape protruding to the outside of the machine. The “label width” is a dimension in a direction orthogonal to a direction in which the label is conveyed out from the label printer 11, that is, a width direction. The “label length” is a length in a direction in which the label is conveyed out from the label printer 11, that is, a size in a length direction.

The label printer 11 is connected to the terminal 12 by wireless LAN communication such as Wi-Fi (registered trademark) or short-range wireless communication such as Bluetooth (registered trademark). Further, the label printer 11 and the terminal 12 may be connected by wire using a USB communication standard.

There are a plurality of types of tapes usable in the label printer 11. For example, a type of the tape may be distinguished depending on a width of the tape, may be distinguished depending on a color of the tape or the ink, or may be distinguished depending on the material of the tape or the presence or absence of the special processing. A model of a label printer compatible with the tape is determined in advance depending on the type of the tape. The user can replace the label printer with a tape of a type suitable for the purpose or application among a plurality of types of tapes corresponding to the model of the label printer to perform printing.

For example, the medium information which is information regarding the tape includes a plurality of items such as a tape width, a tape color, an ink color and a tape type of the tape. The medium information may include a tape model number. The tape type is, for example, a cloth tape or a laminated tape to be laminated. In the tape cassette that accommodates the tape, holes having different formation positions and shapes are formed for each item of the medium information. The label printer 11 can detect a parameter set in each item of the medium information based on the hole formed in the tape cassette mounted on a main body. Hereinafter, the medium information detected by the label printer 11 is referred to as “main body medium information”. The main body medium information may be stored in the label printer 11 or may be stored in an external device. The main body medium information may be stored in an IC chip provided in the tape cassette, and the label printer 11 may include a reading device that reads the IC chip.

The client application 13 according to the present embodiment has a function of acquiring the main body medium information from the label printer 11 and passing the main body medium information to the label management server 22. This function will be described later.

A user database (hereinafter referred to as “user DB”) 25 and a label database (hereinafter referred to as “label DB”) 26 are connected to the interface 227 of the label management server 22 via a wired LAN24. The user DB25 and the label DB26 may be included in the label management server 22 or may be included in a server different from the label management server 22. Further, the user DB25 and the label DB26 may be included in different servers. The user DB25 and the label DB26 will be described later.

The server program 228 stored in the label management server 22 is a program for controlling an operation of the label management server 22. The server program 228 has a function of receiving posted label data (hereinafter referred to as “posting label data”) and registering the label data in the label DB26. The server program 228 has a function of transmitting label data registered in the label DB26 to the terminal 12. Further, the server program 228 has a function of causing the terminal 12 to propose label data corresponding to the main body medium information output by the terminal 12. Functions of the server program 228 will be described later. The server program 228 is an example of a “program executable by a server”.

Next, an operation of the system 100 will be described. In the system 100, the posting label data is shared by posting the label data to the label management server 22 and transmitting the posting label data, which is the posted label data, from the label management server 22 to the terminal 12. Hereinafter, a user registration procedure will be described, and then a label posting procedure, a download procedure, and a printing procedure will be described.

Processing steps in the present embodiment basically indicate processes of the CPUs 221 and 121 according to instructions mainly described in programs such as the server program 228 and the client application 13. The processes by the CPUs 221 and 121 also include hardware control using API of the OS. In the present specification, a detail description of the OS is omitted, and an operation of each program is described.

### User Registration Procedure

A user who uses the system 100 performs user registration in the label management server 22, for example, when installing the client application 13 in the terminal 12. For example, when the terminal 12 requests the label management server 22 to perform user registration, the label management server 22 provides and displays a user registration screen on the terminal 12. The user registration screen includes, for example, a user name input field, a password setting field, and a model name input field. Upon receiving an input of a user name or the like via the user registration screen, the label management server 22 registers the received information in the user DB25.

The user registration may be performed when the client application 13 is not installed, for example, when the user posts the label data first or when the user first downloads the label data.

### Posting Procedure

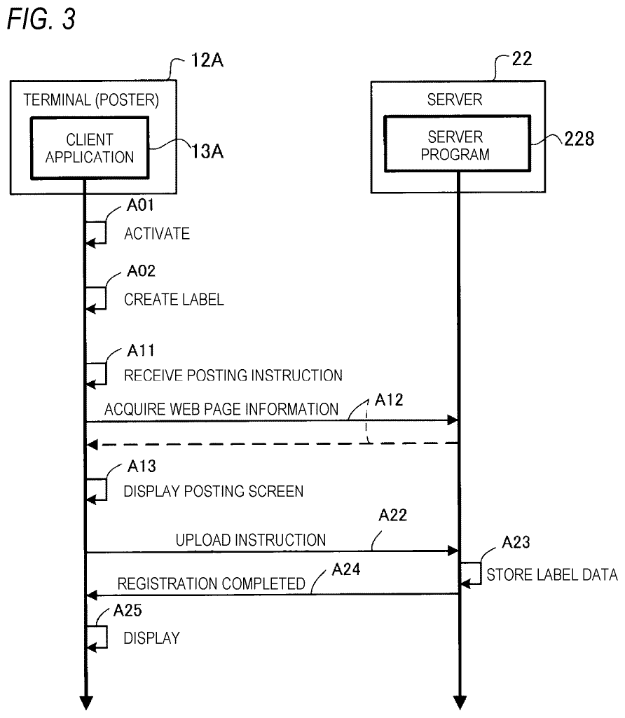

The label data posting procedure will be described with reference to the sequence diagram of FIG. 3. Here, a case where a user who intends to post label data (hereinafter, referred to as a “poster”) posts label data created by the terminal 12A will be described as an example.

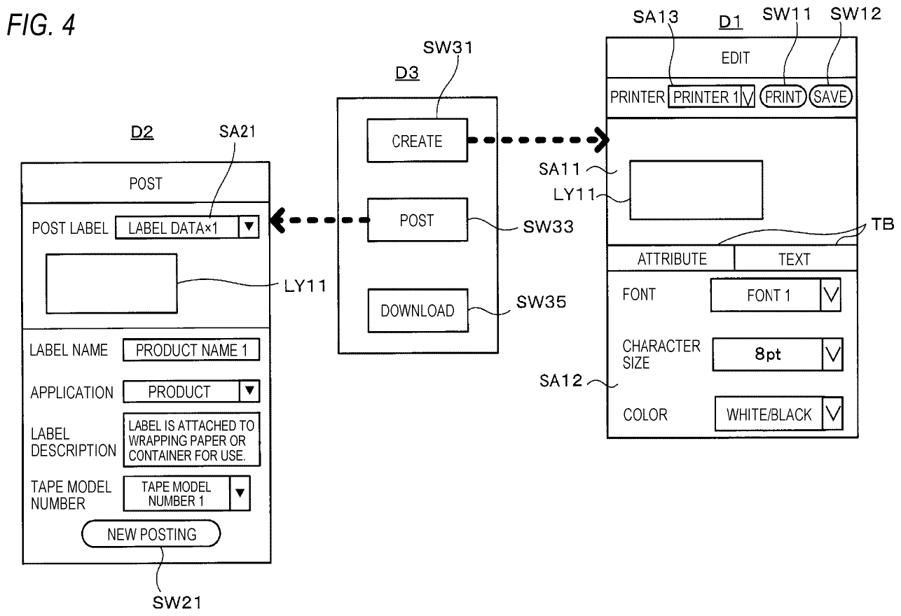

The poster activates the client application 13A installed in the terminal 12A (A01) and creates label data (A02). Specifically, for example, as illustrated in FIG. 4, when the client application 13A is activated, the terminal 12A displays a menu screen D3. The menu screen D3 includes a creation button SW31 for instructing creation of label data, a posting button SW33 for instructing posting of label data, and a download button SW35 for instructing downloading of label data.

When the creation button SW31 is operated, the terminal 12A displays an editing screen D1. The editing screen D1 includes a printer selection field SA13, an editing area SA11, a setting area SA12, a print button SW11, and a save button SW12. The printer selection field SA13 can display a list of printers registered in the client application 13A or the terminal 12A, and receive selection of a printer to perform printing. In the present embodiment, the label printer 11A is selected in the printer selection field SA13.

The editing area SA11 is an area for receiving editing of a label. In the editing area SA11, label image data LY11 of a label to be edited is displayed. The setting area SA12 can receive various types of setting information according to the capability of the selected label printer. The various types of setting information include, for example, medium information related to a tape used for printing the label data. The medium information includes, for example, a tape width, a tape color, an ink color, and a tape type of a tape used for printing a label.

The editing screen D1 allows the user to edit the label image data even when the terminal 12A is offline. Therefore, the medium information set on the editing screen D1 may not match the main body medium information of the selected label printer.

Since there are many items that can be received on the editing screen D1, the client application 13A can receive an instruction to switch the item to be set by a plurality of tabs TB.

When the user edits the label image data LY11 and operates the save button SW12, the client application 13A stores, in the memory 122 of the terminal 12A, label data including the edited label image data LY11 and various types of setting information received in the setting area SA12. After storing the label data in the memory 122, the client application 13A closes the editing screen D1 and causes the terminal 12A to redisplay the menu screen D3. When the print button SW11 is operated, a printing process is executed. The printing process will be described later.

As illustrated in FIG. 3, when the posting button SW33 on the menu screen D3 is operated, the client application 13A receives a posting instruction (A11). The posting button SW33 is associated with a URL of a posting screen provided by the label management server 22. When the client application 13A has a browser function, the client application 13A accesses the label management server 22 using the browser function of the client application 13A and causes the terminal 12A to display a posting screen (A12, A13). When the client application 13A does not have a browser function, the client application 13A passes the URL to another program such as a browser installed in the terminal 12A. The other program accesses the label management server 22 using the URL received from the client application 13A, and causes the terminal 12A to display a posting screen.

For example, the posting screen D2 illustrated in FIG. 4 includes a posting target selection unit SA21 and a new posting button SW21.

As illustrated in FIG. 3, when the new posting button SW21 is operated, the label management server 22 receives an upload instruction in which the user IDs and the posting label data are associated with each other (A22), and registers the posting label data (hereinafter referred to as “posting label data”) in the label DB26 in association with the user IDs (A23). The process of A22 is an example of an “upload reception process”. The process of A23 is an example of a “registration process”. For example, when acquiring the user ID from the client application 13A, the label management server 22 may register the acquired user ID and the posting label data in the label DB26 in association with each other. Further, for example, when the login operation is performed using the user IDs and a password at the time of activating the client application 13A or at the time of receiving the upload instruction, the label management server 22 may register the user IDs used for the login operation and the posting label data in the label DB26 in association with each other.

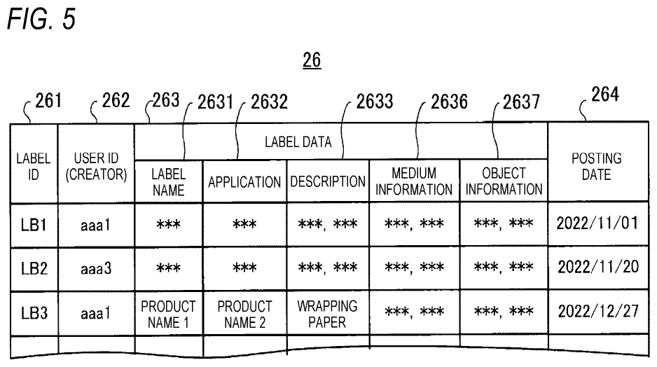

For example, the label DB26 illustrated in FIG. 5 stores label data shared by the label management server 22. The label data stored in the label DB26 includes not only the posting label data but also label data prepared by a vendor of a printer manufacturer. The label DB26 includes a record in which a label ID261, a user ID (creator) 262, label data 263, and a posting date 264 are associated with each other.

The label ID261 is a serial number sequentially assigned to each label data registered in the label DB26 in the system 100 according to the present embodiment. The user ID (creator) 262 is a user ID251 of the user. When the creator of the label data is a user registered in the user DB25, the user ID251 of the creator is stored in the user ID262. When the creator of the label data is the vendor of the printer, nothing may be stored in the user ID (creator) 262, or information for identifying the vendor may be stored.

The label data 263 stores information related to labels. The label data 263 includes, for example, a label name 2631, an application 2632, description 2633, medium information 2636, and object information 2637. The label name 2631 stores a label name. Information indicating the application of the label is stored in the application 2632. Information indicating the description of the label is stored in the description 2633. For example, information received via the posting screen D2 is stored in the label name 2631, the application 2632, and the description 2633. The medium information 2636 stores information related to labels and tapes. The object information 2637 stores information on an object used for the label data. When the setting of the tape model number is received on the posting screen D2, the label DB26 may store the tape model number.

As illustrated in FIG. 3, when the registration of the posting label data is completed, the label management server 22 notifies the terminal 12A that is a transmission source of the posting label data of the registration completion (A24). The terminal 12A displays the registration completion notification (A25).

### Printing Procedure

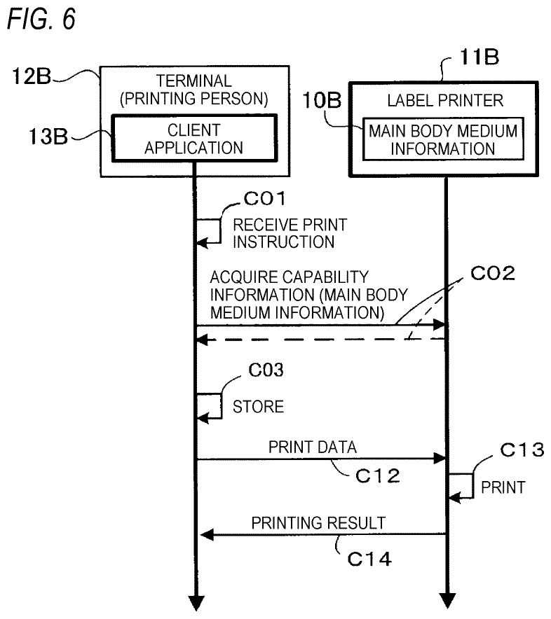

Next, a printing procedure will be described with reference to FIG. 6. For example, when printing the label data, the printing person operates the creation button SW31 of the menu screen D3 illustrated in FIG. 4 to display the editing screen D1 on the operation display unit 126 of the terminal 12B. The client application 13B receives selection of label data, which is a print target, using the operation display unit 126. The print target may be label data created by the printing person or label data downloaded from the label management server 22 by the printing person. When the editing screen D1 is operated, the client application 13B can receive editing of label data, which is a print target.

When the print button SW11 is operated, the client application 13B receives a print instruction (C01). When the label printer 11B is selected in the printer selection field SA13 of the editing screen D1, the client application 13B acquires the capability information from the label printer 11B (C02). The capability information includes the main body medium information 10B of a tape attached to the label printer 11B. C02 is an example of a “main body acquisition process”. Since the client application 13B acquires the main body medium information 10B from the label printer 11B that actually performs printing, the client application 13B can acquire the main body medium information 10B of a tape to be actually used.

The client application 13B stores the acquired main body medium information 10B in the memory 122 (C03). C03 is an example of a “storage process”. When the main body medium information is stored in the memory 122, the client application 13B overwrites the existing main body medium information with the acquired main body medium information 10B. Accordingly, the latest main body medium information 10B actually used in the label printer 11B is stored in the terminal 12B.

The client application 13B transmits print data based on the label data, which is a print target, to the label printer 11B (C12). The label printer 11B performs printing based on the print data (C13) and transmits a printing result to the terminal 12B (C14). The label printer 11B may not transmit the printing result.

### Download Procedure

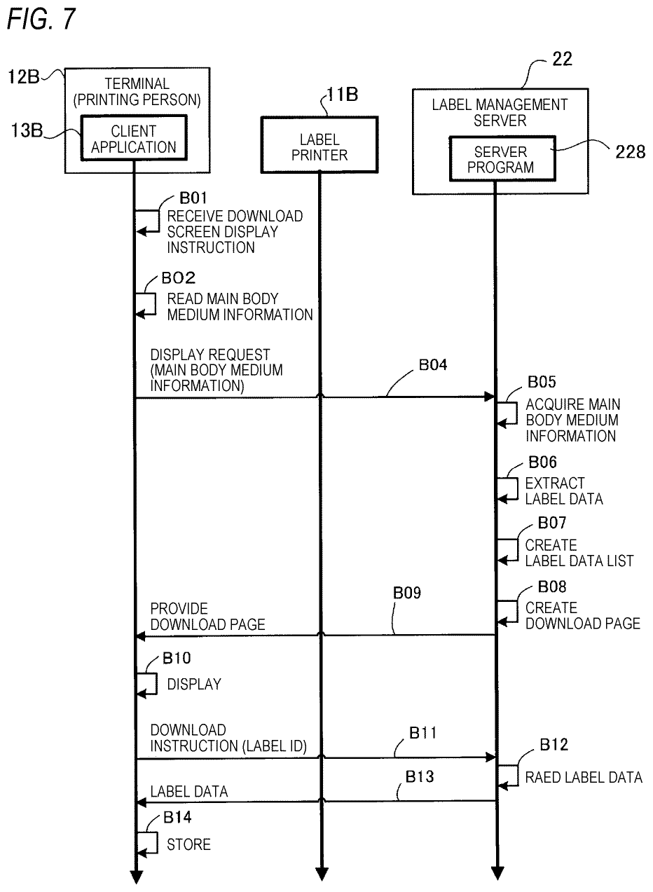

A procedure for downloading label data will be described with reference to FIG. 7. Here, a case where the printing person downloads the label data from the label management server 22 to the own terminal 12B will be described as an example. Here, it is assumed that the terminal 12B stores the main body medium information 10B acquired from the label printer 11B.

When the download button SW35 on the menu screen D3 illustrated in FIG. 4 is operated, the client application 13B installed in the terminal 12B receives a download screen display instruction (B01). The client application 13B reads the main body medium information 10B from the memory 122 (B02).

The download button SW35 of the menu screen D3 illustrated in FIG. 4 is associated with a URL of a download screen provided by the label management server 22. For example, the client application 13B accesses the URL of the download screen using its own browser function, and requests to display a download page (B04). The display request is associated with the main body medium information 10B read in B02. The process of B04 is an example of a “transmission process”. The download screen display instruction is an example of a “predetermined instruction”. B01 is an example of a “reception process”. The display request is an example of a “list request”.

When the client application 13B does not have a browser function, the client application 13B passes the URL and the main body medium information to another program such as a browser. The other program makes a display request to the label management server 22 based on the URL. The client application 13B may embed the main body medium information 10B in a query of the URL.

When receiving the display request using the network IF225 (B04), the label management server 22 acquires the main body medium information 10B associated with the display request (B05). The process of B05 is an example of an “acquisition process”.

The label management server 22 accesses the label DB26 using the interface 227 and extracts a record including the medium information corresponding to the main body medium information 10B acquired in B05, that is, label data from the label DB26 (B06). The medium information includes a plurality of items such as a tape width, a tape color, an ink color and a tape type. The process of B06 is an example of an “extraction process”.

The medium information corresponding to the main body medium information 10B includes completely matching medium information in which all items included in the medium information match the main body medium information 10B. For example, when the medium information and the main body medium information of the label data include the tape model number, the label data in which the tape model number of the medium information matches the tape model number of the main body medium information is extracted.

The medium information corresponding to the main body medium information 10B includes partially matching medium information in which a part of the items included in the medium information match the main body medium information 10B. For example, label data in which the tape width matches the main body medium information 10B and the tape color, the ink color, and the tape type are different are also extracted.

Further, in the medium information corresponding to the main body medium information 10B, a part of the items included in the medium information may include the main body medium information 10B and similar medium information. For example, label data including a tape width within ±10% with respect to the tape width of the main body medium information 10B or label data having a similar tape color may be extracted.

The label management server 22 creates a label data list including the label data extracted in B06 (B07). The label data list may include all or only a part of information included in the extracted label data. For example, the label data list may include only sample images, label names, and label IDs.

The label management server 22 may create a label data list by assigning priorities to the label data extracted in B06. For example, the label management server 22 may cause the label data list to have a priority in which a display order of the label data is set to the label data including the completely matching medium information, the label data including the partially matching medium information, and the label data including the similar medium information from the top.

Further, for example, when there are a plurality of pieces of label data including the partially matching medium information, the label management server 22 may set a priority order among the label data. For example, the label data having more items matching the main body medium information 10B may be displayed at a higher rank.

If the number of pieces of label data to be proposed is large, the display of the recommended label data may be complicated. Therefore, the label management server 22 may limit the number of pieces of label data to be included in the label data list. In this case, the label management server 22 may register the label data in the label data list in descending order of priority.

The label management server 22 creates a download page including the label data list generated in B07 (B08), and transmits the download page to the terminal 12 that is a transmission source of the display request (B09). The process of B09 is an example of a “return process”. When the main body medium information 10B is not attached to the display request, the label management server 22 may return the label data list including all the label data registered in the label DB26, may not return the label data list as an error, or may return the label data list including the label data extracted according to other conditions when other conditions are attached.

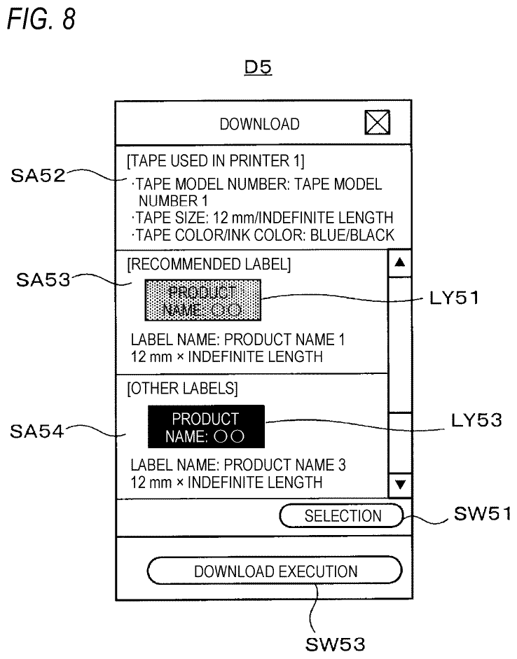

The terminal 12B displays the download page provided from the label management server 22, that is, a download screen (B10). The process of B10 is an example of “a process of proposing label data included in the received label data list”. FIG. 8 illustrates an example of the download screen. The download screen D5 includes a main body medium information display area SA52, a recommended label display area SA53, another label display area SA54, a selection button SW51, and a download execution button SW53.

The main body medium information display area SA52 is an area for displaying the main body medium information 10B associated with the display request received in B04. The recommended label display area SA53 is an area for displaying label data corresponding to the main body medium information 10B. In the present embodiment, the label data having the highest priority among the label data included in the label data list is displayed in the recommended label display area SA53. For example, label image data LY51 of the label data including the completely matching medium information is displayed in the recommended label display area SA53. In the other label display area SA54, the label image data of the label data having the second or lower priority among the label data included in the label data list is displayed. For example, label image data LY53 including partially matching medium information and label image data including similar medium information are displayed in the other label display area SA54.

The selection button SW51 is an operator for confirming selection of label data. In the present embodiment, in the label management server 22, the medium information not corresponding to the main body medium information 10B is not included in the label data list and is not displayed on the download screen D5. Therefore, it is possible to prevent the printing person from selecting label data not corresponding to the main body medium information 10B on the download screen D5.

For example, when the printing person operates the selection button SW1 and the download execution button SW53 in a state where the label image data LY51 is selected, the label management server 22 receives a download instruction as illustrated in FIG. 7 (B11). The label ID of the label data corresponding to the label image data LY51 is associated with the download instruction. The label management server 22 reads the label data corresponding to the label ID associated with the download instruction from the label DB26 (B12), and transmits the label data to the terminal 12B that is a transmission source of the download instruction (B13). Upon receiving the label data, the terminal 12B stores the label data in the memory 122 (B14). The label data to be downloaded may be posting label data registered in the label DB26 by the posting procedure described above, or may be label data registered in the label DB26 by a vendor or the like.

As described above, when there is a display request from the terminal 12B, the server program 228 according to the first embodiment uses the main body medium information 10B acquired by the terminal 12B from the label printer 11B to extract label data including medium information corresponding to the main body medium information 10B from the label DB26. Accordingly, the label data suitable for the tape attached to the label printer 11B to which the terminal 12B is connected is listed up. The server program 228 returns, to the terminal 12B, a label data list including the extracted label data. According to such a server program 228, it can be expected to propose label data suitable for the user of the terminal 12.

### Second Embodiment

Next, a second embodiment of the technique disclosed in the present specification will be described. In the technique of the second embodiment, a printing log including main body medium information is stored, and when there is a display request, a label management server 22A acquires the main body medium information from the printing log. This point is different from the first embodiment in which the client application 13 acquires the main body medium information from the label printer 11 and passes the main body medium information to the label management server 22. Hereinafter, differences from the first embodiment will be described, and points common to the first embodiment will be denoted by the same reference numerals as the first embodiment, and description thereof will be omitted as appropriate.

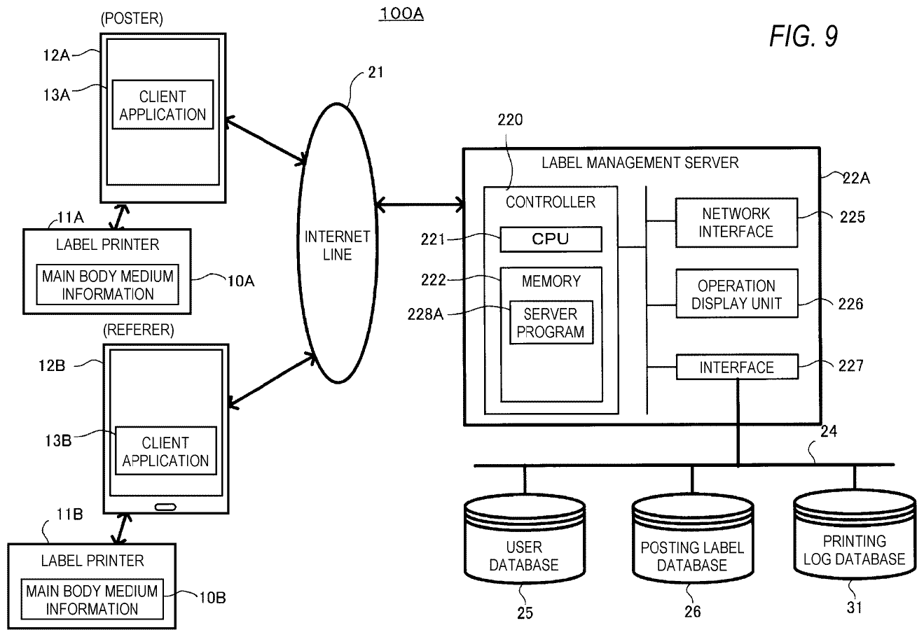

As illustrated in FIG. 9, in a label data sharing system 100A (hereinafter, referred to as a “system 100A”) according to the second embodiment, a label management server 22A can access a printing log database (hereinafter, referred to as a “printing log DB”) 31. The printing log DB31 may be in the label management server 22A or may be in a server different from the label management server 22A.

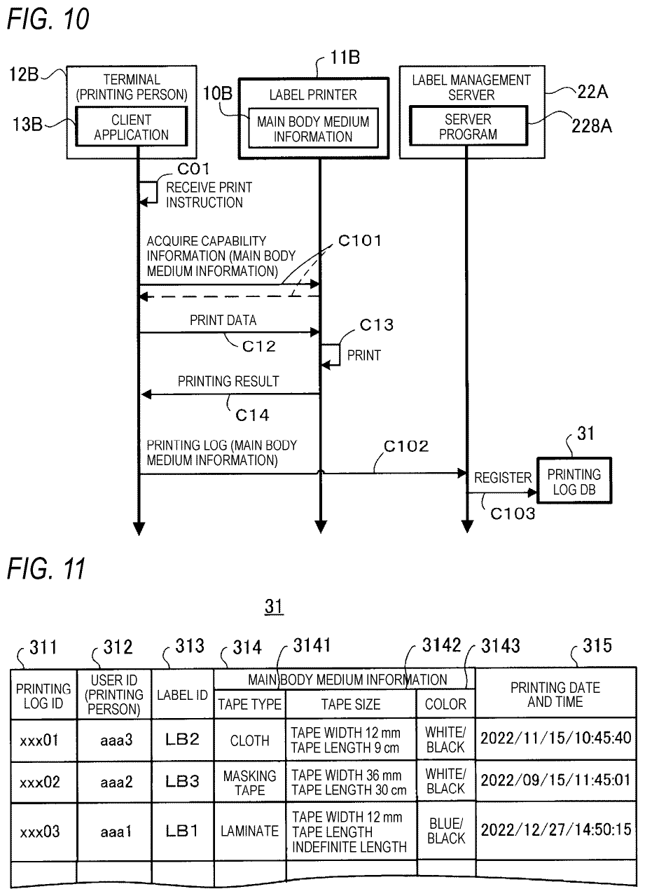

As illustrated in FIG. 10, when receiving the print instruction (C01), the client application 13B of the terminal 12B acquires the capability information from the label printer 11B (C101). The capability information includes the main body medium information 10B. When the label printer 11B receives the print data from the client application 13B and prints the print data (C12, C13), the label printer 11B transmits a printing result to the terminal 12B that is a transmission source of the print data (C14). The label printer 11B may not transmit the printing result to the terminal 12B.

When causing the label printer 11B to perform printing, the client application 13B transmits, to the label management server 22A, the printing log including the main body medium information 10B acquired in C101 (C102). A server program 228A of the label management server 22A registers the received printing log in the printing log DB31 (C103). The process of C103 is an example of a “storage process”.

For example, the printing log DB31 illustrated in FIG. 11 accumulates and stores the printing log received from the label printer 11. The printing log DB31 includes a record including a printing log ID311, a user ID (printing person) 312, a label ID313, main body medium information 314, and a printing date and time 315. The items of the main body medium information 314 include, for example, a tape type 3141, a tape size 3142, and a color 3143. The item of the main body medium information 314 may include a tape model number.

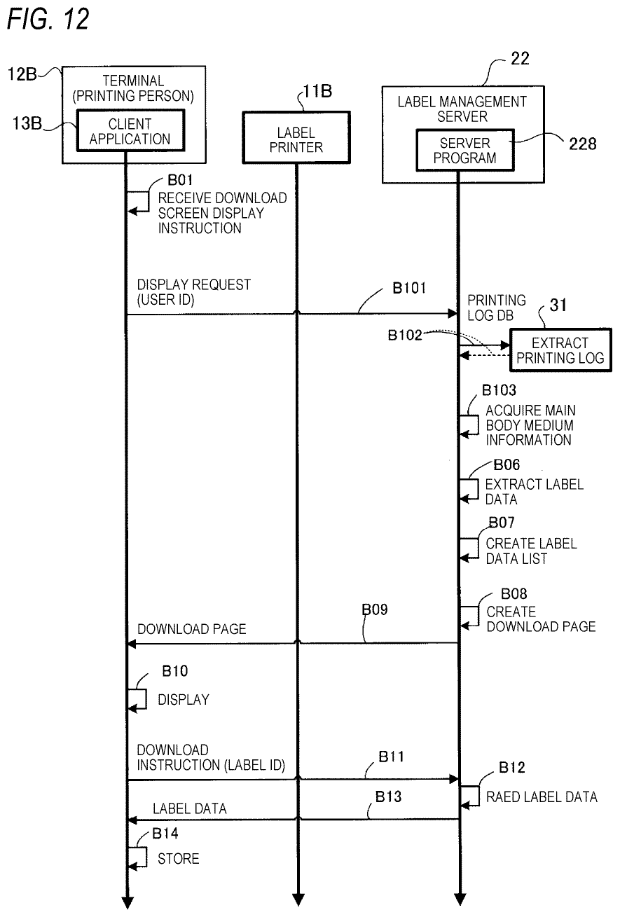

The download procedure will be described. For example, as illustrated in FIG. 12, when the client application 13B receives the download screen display instruction (B01), the client application 13B transmits a display request to the label management server 22A (B101). In the present embodiment, the display request is associated with the user ID, but is not associated with the main body medium information.

When receiving the display request using the network IF225, the label management server 22A accesses the printing log DB31 using the interface 227. The label management server 22A extracts, from the printing log DB31, a printing log including the user ID associated with the display request (B102). In the present embodiment, the label management server 22A extracts one or a plurality of printing logs registered in the printing log DB31 within a predetermined period from the current time (for example, within one week from the current time). According to this, the one or the plurality of pieces of main body medium information used most recently can be acquired, and label data suitable for a recent tape use tendency of the user can be proposed.

The label management server 22A acquires the main body medium information 314 from the printing log extracted from the printing log DB31 (B103). The process of B103 is an example of an “acquisition process”. Thereafter, the label management server 22A executes the processes of B06 to B09 and causes the terminal 12B to display the download page including the label data list.

When a plurality of printing logs are extracted in B102, the label management server 22A acquires the main body medium information 314 from each printing log. Some users use a plurality of tapes having different tape widths, colors, tape types, and the like by replacing the tapes with the label printer 11. In order to cope with such a user, the label management server 22A according to the present embodiment may acquire a plurality of pieces of main body medium information 314 from the plurality of printing logs. The label management server 22A proposes the label data based on the plurality of pieces of main body medium information 314, so that it can be expected to propose label data suitable for the use tendency of the user.

When the label management server 22A cannot extract the printing log in B102, the label management server 22A may return the label data list including all the label data registered in the label DB26 in B07 or may not return the label data list as an error.

As described above, by acquiring the main body medium information 314 included in the printing log, the server program 228A according to the second embodiment can acquire the main body medium information 314 when the terminal 12B causes the label printer 11B to perform printing, and there is a high possibility that label data suitable for the user is proposed. Further, for example, even when the download screen display instruction is received in a state where the terminal 12B is not connected to the label printer 11B in B01, the server program 228A can acquire the main body medium information 10B of the label printer 11B from the printing log, return the label data list to the terminal 12B, and propose the label data suitable for the user.

The embodiments disclosed in the present specification are merely an example, and does not limit the present invention. Therefore, various improvements and modifications can be naturally made to the technique disclosed in the present specification without departing from the gist of the present invention. The number of label printers 11 connected to the terminal 12 is not limited to the illustrated example, and may be two or more.

When checking consumables attached to the label printer 11B, the client application 13B may acquire the main body medium information 10B from the label printer 11B and store the main body medium information 10B in the memory 122 of the terminal 12B. This process is an example of a “storage process”. The timing of acquiring the main body medium information 10B may be both when the consumables are checked and when the print instruction is received, or may be either when the consumables are checked or when the print instruction is received.

Each time the download screen display instruction is issued in B01 of FIG. 7, the client application 13B may acquire the main body medium information 10B from the label printer 11B and transmit the main body medium information 10B to the label management server 22 in association with the display request. According to this, the label management server 22 can propose the label data suitable for the tape actually attached to the label printer 11. However, since the client application 13B acquires the main body medium information 10B from the label printer 11B and stores the main body medium information 10B in the memory 122 at the time of checking consumables or performing printing, even when the label printer 11B is offline, the client application 13B can transmit the main body medium information to the label management server 22 in association with display information, and the label management server 22 can propose the label data.

For example, C101 in FIG. 10 may be omitted, and the client application 13B may receive the printing result including the main body medium information 10B from the label printer 11B and transmit, to the label management server 22A, the printing log including the main body medium information 10B included in the printing result in C14. According to this, the printing log including the main body medium information 10B of the actually used tape is stored in the printing log DB31. However, since the client application 13B acquires the capability information including the main body medium information 10B from the label printer 11B and includes the capability information in the printing log, the printing log including the main body medium information can be registered in the printing log DB31 regardless of whether the label printer has a function of outputting the printing result.

The label management server 22, 22A may include a first server having a web server function and a second server having a function different from the web server function. For example, the first server may receive a list request by a web server function and transmit the label data list. On the other hand, the second server may extract the main body medium information corresponding to the user ID and extract the label data from the label database. The first server and the second server may cooperate to receive the list request, extract the main body medium information and the label data, and transmit the label data list.

When there are a plurality of printing logs associated with the user IDs in the printing log DB31 in B102 of FIG. 12, the label management server 22A according to the second embodiment may extract one latest printing log. According to this, the label management server 22A can acquire the main body medium information 314 of a tape that is highly likely to be currently attached to the label printer 11B, and there is a high possibility that label data more suitable for the user is proposed. However, by extracting a printing log within the predetermined period from the current time, one or a plurality of pieces of most recently used main body medium information can be acquired, and there is a high possibility that label data more suitable for the recent tendency of the user is proposed.

In B102 of FIG. 12, the label management server 22A according to the second embodiment may acquire a plurality of printing logs by acquiring all printing logs including the user ID or acquiring a predetermined number of printing logs in order from the latest printing log.

In the process of B06 in FIGS. 7 and 12, only label data that completely matches the main body medium information 10B, 314 may be extracted. According to this, the server program can propose the label data suitable for the tape currently attached to the selected label printer 11. However, by extracting label data in which a plurality of items are present in the medium information and some of the items match the main body medium information, there is a high possibility that the label data is extracted, and more label data can be proposed.

Only the posting label data may be registered in the label DB26, and the server program 228, 228A may extract the posting label data from the label DB26 based on the main body medium information 10, 314 and return a list of the posting label data to the terminal 12. As described above, the posting label data can be proposed based on the main body medium information 10, 314, so that the use of the posting label data can be promoted. However, the label DB26 stores not only the posting label data but also label data produced by a person other than the user, such as label data prepared by the vendor, and the label management server 22, 22A can propose label data other than the posting label data based on the main body medium information 10, 314, thereby increasing the types of label data to be proposed.

For example, the client application 13B may include a browsing button for instructing browsing of label data, and may propose label data recommended to be included in a browsing result when the browsing instruction is received. According to this, an operation for displaying the proposal of the label data is reduced, and the labor of the user is reduced. The client application 13B may independently include an operator for instructing proposal of label data and may directly receive an instruction to be proposed to propose the label data. According to this, the label management server 22 can propose suitable label data at a timing preferred by the user.

The display of each screen is not limited to the above embodiments. For example, the download screen D7 may not include at least one of the main body medium information display area SA72 and the other label display area SA74.

In any sequence diagram disclosed in the embodiments, an execution order of a plurality of processes can be freely changed or can be executed in parallel within a range in which no contradiction occurs in a processing content.

The processes disclosed in the embodiments may be executed by hardware such as a single CPU, a plurality of CPUs, and an ASIC, or a combination thereof. In addition, the processes disclosed in the embodiments can be implemented in various modes such as a recording medium in which a program for executing the processes is recorded, or a method.

When there is a list request from the information processing device, the program having the above configuration acquires the main body medium information acquired by the information processing device from a label printer, and extracts the label data including the medium information corresponding to the main body medium information from the label database. Accordingly, the label data suitable for the printing medium attached to the label printer to which the information processing device is connected is listed up. The program returns a label data list including the extracted label data to the information processing device. According to such a program, it can be expected to propose label data suitable for the user of the information processing device.

A server for realizing the functions of the program, a label data sharing system, a computer-readable storage medium storing the program, a program executable by an information processing device, and a computer-readable storage medium storing the program executable by the information processing device are also novel and useful.

According to the technique disclosed in the present specification, a technique capable of recommending label data suitable for a user in a system for sharing label data is realized.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. A non-transitory computer readable storage medium storing a program executable by a server, the server being capable of accessing a label database, the label database being capable of registering a plurality of piece of label data, the label data including medium information indicating a printing medium, wherein
the program causes a computer of the server to execute,
when a list request is received from the information processing device,
an acquisition process of acquiring, by an information processing device, main body medium information which is medium information acquired from a label printer,
an extraction process of accessing the label database and extracting the label data including medium information corresponding to the main body medium information acquired in the acquisition process, and
a return process of returning, to the information processing device, a label data list including the label data extracted in the extraction process.

2. The storage medium according to claim 1, wherein
the list request may be associated with the main body medium information,
the program causes the computer of the server to execute,
when the list request associated with the main body medium information is received from the information processing device, the acquisition process, the extraction process, and the return process, and
in the acquisition process,
the main body medium information associated with the list request is acquired.

3. The storage medium according to claim 1, wherein
the list request is associated with a user ID,
the program is capable of causing the computer of the server to execute
a storage process of storing a printing log, the printing log is output from the information processing device when the information processing device causes the label printer to perform printing, the printing log includes the user ID and the main body medium information acquired from the label printer at the time of performing printing by the information processing device, and
in the acquisition process,
the printing log including the user ID associated with the list request is extracted from the printing logs stored in the storage process, and the main body medium information included in the extracted printing log is acquired.

4. The storage medium according to claim 3, wherein
in the acquisition process,
when there are a plurality of printing logs including the user ID associated with the list request, the latest printing log is extracted.

5. The storage medium according to claim 3, wherein
in the acquisition process,
the printing log that includes the user ID associated with the list request and that is stored within a predetermined period from a current time is extracted from the printing logs stored in the storage process, and the main body medium information included in the extracted printing log is acquired.

6. The storage medium according to claim 1, wherein
in the extraction process,
the label data including the medium information matching the main body medium information acquired in the acquisition process is extracted.

7. The storage medium according to claim 1, wherein
the medium information includes a plurality of items, and
in the extraction process,
the label data including the medium information matching at least some items of the main body medium information acquired in the acquisition process is extracted.

8. The storage medium according to claim 1, wherein
the program is capable of causing the computer of the server to execute an upload reception process of receiving an upload instruction of label data, and further causing the computer of the server to execute,
when the upload instruction is received in the upload reception process, a registration process of receiving posting label data, which is the uploaded label data, and registering the received posting label data in the label database, and
in the extraction process,
the posting label data including medium information corresponding to the main body medium information acquired in the acquisition process is extracted.

9. A server connectable to an information processing device via a network, wherein
the server is capable of accessing a label database, the label database is capable of registering label data, the label data includes medium information indicating a printing medium, and
the server is further configured to execute,
when a list request is received from the information processing device,
an acquisition process of acquiring main body medium information, which is medium information acquired from a label printer by the information processing device,
an extraction process of accessing the label database and extracting the label data including medium information corresponding to the main body medium information acquired in the acquisition process, and
a return process of returning, to the information processing device, a label data list including the label data extracted in the extraction process.

10. A non-transitory computer readable storage medium storing a program executable by an information processing device connectable to a label printer, wherein
the program is capable of causing a computer of the information processing device to execute,
a main body acquisition process of acquiring medium information indicating a printing medium attached to the label printer from the label printer,
a reception processing of receiving a predetermined instruction indicating a proposal request of label data via a user interface of the information processing device, and
a transmission process of transmitting, when the predetermined instruction is received in the reception process, a list request to a server in association with main body medium information, which is medium information acquired in the main body acquisition process,
the server is capable of accessing a label database, the label database is capable of registering a plurality of piece of label data, the label data includes medium information indicating a printing medium, and upon receiving the list request, the server returns a label data list of label data including medium information corresponding to the main body medium information associated with the list request,
the program further causes the computer of the information processing device to execute,
when the label data list is received from the server, a process of proposing the label data included in the received label data list.

11. The storage medium according to claim 10, wherein
the program causes the computer of the information processing device to execute,
when the predetermined instruction is received in the reception process, a main body acquisition process before executing the transmission process.

12. The storage medium according to claim 10, wherein
the program causes the computer of the information processing device to execute,
when the label printer is caused to perform printing, the main body acquisition process and further execute a storage process of storing the main body medium information acquired in the main body acquisition process, and
when the predetermined instruction is received in the reception process, the main body medium information stored in the storage process is read and the list request is transmitted to a server in association with the read main body medium information in the transmission process.

13. A label data sharing system comprising an information processing device and a server, the information processing device being connectable to the server via a network, wherein
the server is capable of accessing to a label database, the label database is capable of registering a plurality of piece of label data, and medium information indicating a printing medium is included in the label data,
the information processing device is capable of executing,
a main body acquisition process of acquiring, from a label printer, medium information indicating a printing medium attached to the label printer,
a reception process of receiving a predetermined instruction indicating a proposal request of label data via a user interface of the information processing device, and
a transmission process of transmitting, when the predetermined instruction is received in the reception process, a list request to the server in association with main body medium information, which is medium information acquired in the main body acquisition process,
the server is configured to execute,
when the list request is received from the information processing device,
an acquisition process of acquiring the main body medium information,
an extraction process of accessing the label database and extracting the label data including medium information corresponding to the main body medium information acquired in the acquisition process, and
a return process of returning, to the information processing device, a label data list including the label data extracted in the extraction process,
the information processing device is configured to execute,
when the label data list is received from the server, a process of proposing the label data included in the received label data list.
